(19) United States
(12) Patent Application Publication
(10) Pub. No.: US 2026/0278389 A1
(43) Pub. Date: Sep. 17, 2026

(54) ACCELERATED TRAINING OF MODELS

(71) Applicant: Aible Inc., Pleasanton, CA (US)

(72) Inventors: Arijit Sengupta, Las Vegas, NV (US); Jonathan Wray, Lago Vista, TX (US)

(21) Appl. No.: 19/566,426

(22) Filed: Mar. 13, 2026

Related U.S. Application Data
(60) Provisional application No. 63/773,126, filed on Mar. 17, 2025.

(51) Int. Cl. G06N 3/092

(52) U.S. Cl. CPC G06N 3/092

(57) ABSTRACT

Disclosed are systems and methods for the accelerated training of specialized foundation models. A device may receive data characterizing feedback from user feedback to performance of a user application interfacing with an artificial intelligence based model, determine training data by applying a second artificial intelligence based model on the data characterizing feedback to identify one or more training categories and determine a summarization of the data characterizing feedback associated with the identified one or more training categories as the training data, and update the artificial intelligence based model using the determined training data. Related apparatus, systems, techniques, and articles are also described.

### CROSS REFERENCE TO RELATED APPLICATIONS

This application claims priority under 35 U.S.C. § 119 to U.S. Provisional Patent Application No. 63/773,126, filed Mar. 17, 2025, and entitled “Accelerated Training of Models,” the entire disclosure of this application is incorporated herein by reference.

### TECHNICAL FIELD

The subject matter described herein relates to accelerated training of models.

### BACKGROUND

Models including foundation models that incorporate large language models that utilize transformer-based deep learning algorithms are trained on global repositories of data. In order to be used in specific environments, the foundation models may require specialization including customization and extensive training. Organizations may adapt and customize large language models to work for their specific organization. For example, a chatbot for a banking application can require specific training in order to configure the large language model to provide responsive and relevant responses for banking, which may be different from the customizations appropriate for a chatbot that is configured for use by a pharmacy. Specialization and customization of large language models may require the use of specialized knowledge, resources, and involve expert knowledge for prompt engineering and/or fine-tuning, which may also require a large amount of time and resources (e.g., financial expenses, personnel requirements, memory requirements, and/or processing requirements) before the large language model is fully adapted and customized for a specific organization.

### SUMMARY

In an aspect, a method includes receiving data characterizing user feedback related to performance of an application executing on a computing device and interfacing with a first artificial intelligence based model; determining, using at least a second artificial intelligence based model and the received data, a natural language summary of the user feedback; determining using the natural language summary of the user feedback, at least one category of feedback; determining a training data set by at least filtering the data characterizing the user feedback by the at least one category of feedback; and updating the first artificial intelligence based model using the determined training data set.

One or more of the following features can be included in any feasible combination.

For example, the method can include monitoring performance of the application interfacing with the artificial intelligence based model. The method can also include generating data characterizing user feedback to the monitored performance of the application. In some aspects, the data characterizing user feedback includes at least one of a prompt, a response generated by the first artificial intelligence based model corresponding to the prompt, or an indication of user approval or disapproval of the response. The at least one category of feedback can identify a recurrent pattern in the user feedback. Updating the first artificial intelligence based model can include at least one of fine-tuning the first artificial intelligence based model using the determined training data set or applying reinforcement learning to the first artificial intelligence based model using the determined training data set.

In some aspects, the first artificial intelligence based model includes least one of a foundational model, a multi-modal model, a reinforcement learning model, a transfer learning model, or a large language model. In some aspects, the second artificial intelligence model includes a large language model configured to generate summaries of user feedback. In some aspects the second artificial intelligence model includes a large language model trained on user feedback and is configured to generate at least one of summaries of user feedback and/or categories of feedback. In some aspects, determining the training data set is responsive to the received data characterizing user feedback exceeding a training threshold. In some aspects, the training threshold includes at least one of an elapsed time, a run count for the application, and/or a feedback count. In some aspects, the data characterizing user feedback includes a user prompt, a response corresponding to the user prompt, user feedback to the response and/or a retrieval augmented generation (RAG) architecture for the user prompt and corresponding response. In some aspects, the user feedback includes a selection of one or more icons indicating approval and/or disapproval of a provided response.

In some aspects, the method also includes displaying at least one of the data characterizing user feedback, determined training data set, performance of the user application, or updates to the first artificial intelligence model in a graphical user interface. In some aspects, the training data set includes one or more values indicating at least one of a type of the first artificial intelligence based model, a setting of the first artificial intelligence based model, and/or a configuration of the first artificial intelligence based model.

In some aspects, the techniques described herein relate to a method, wherein the setting includes at least one of a temperature, frequency penalty, presence penalty, top p-value, and top k-value, chat tone, quantity of response, and/or type of retrieval.

In some aspects, the training data set is smaller (e.g., memory usage) than the received data characterizing user feedback.

In some aspects, a method includes monitoring performance of a user application interfacing with an artificial intelligence based model; receiving user feedback for the performance of the user application interfacing with the artificial intelligence based model; generating data summarizing the received user feedback by applying a second artificial intelligence based model to the received user feedback; identifying one or more training categories based on the generated data summarizing the received user feedback; determining training data by filtering the received user feedback based on the identified one or more training categories; and fine-tuning the artificial intelligence based model based on the generated training data and/or applying reinforcement learning to the artificial intelligence based model based on the generated training data.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram for a system for accelerated training of models;

FIG. 2 is a flow-chart illustrating a method for accelerated training of models; and

FIG. 3 is a flow-chart illustrating a method for accelerated training of models.

Like reference symbols in the various drawings indicate like elements.

### DETAILED DESCRIPTION

Models (including frontier models) that are based on foundation models, which include large language models that utilize transformer-based deep learning algorithms, undergo specialization or customization in order to provide improved performance in specific environments. Organizations that adopt models for specific uses customize and modify the models to work for their specific organization (e.g., chatbots for a banking application, ChatGPT for medical offices, and the like). However, as the models are adapted for use in specific organizations, they initially are trained on external data, not internal organization data, and may require extensive training on internal organization data before they are able to produce responses that are relevant to the organization. An example of this is the “cold start problem” in which there is not enough information for the foundation model to provide accurate or relevant responses due to scarce data, which can be attributed, for example, to new users, to new items, to scenarios with no or limited prior history data. This results in the large foundation model having limited or no context.

While some organizations have used extensive training, prompt engineering, feedback, or fine-tuning to adapt large language models in specific organizations, such training and fine-tuning requires extensive amount of time and resources.

Accordingly, some implementations of the current subject matter can capture contextual information regarding the input and output from models in order to provide more efficient and accelerated techniques for training models such as transformer-based deep learning trained large language models to be organization specific or specialized.

For example, in some implementations, user feedback on the performance of a first artificial intelligence based model such as a transformer-based deep learning trained large language model can be summarized using a second artificial intelligence based model. The user feedback can include data characterizing user reaction to the responses provided by the first artificial intelligence based model to user queries. A second artificial intelligence model can be used to determine a summarization of the user feedback and to identify one or more feedback concepts. The concepts and the summarization can be used to filter the user feedback and generate a training data set based on one or more of the training categories. The first artificial intelligence based model can then be updated using the generated training data. Some implementations can utilize a second artificial intelligence based model to characterize the feedback and generate feedback-based training data that can be used to update the first artificial intelligence model, which may include a transformer-based deep learning trained large language model. By utilizing a second artificial intelligence based model such as a large language model to summarize user feedback to generate training data, the first artificial intelligence model can be specialized using fewer training resources (e.g., prompt engineers, data processors) in less time, allowing for the accelerated training of foundation models. Accordingly, some implementations of the current subject matter provide a more efficient means of customizing and adapting models that does not require extensive prompt engineering, or other time and resource consuming training methods.

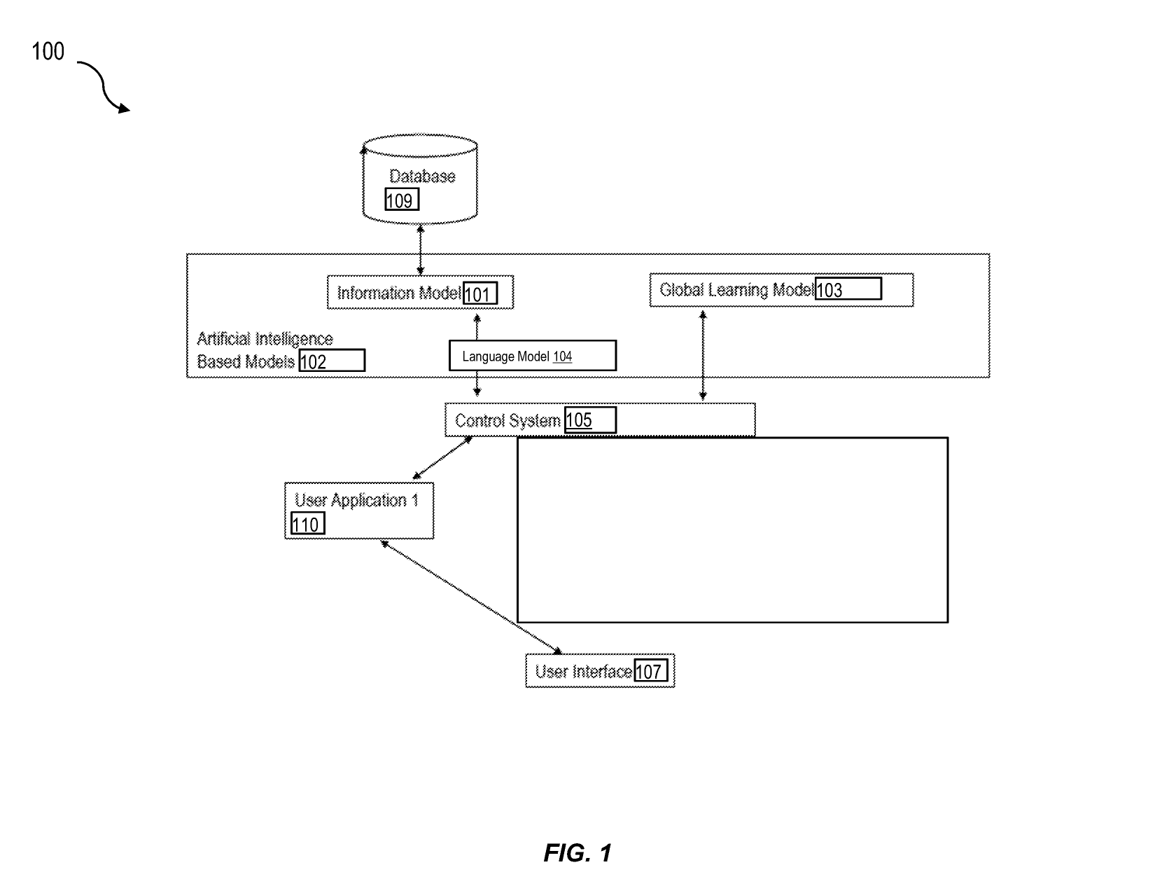

FIG. 1 provides an example diagram of a system 100 built in accordance with the current disclosure which allows for the accelerated training of large models including foundation models, generative models, large language models, and the like. The illustrated system 100 may include artificial intelligence models 102, which may include information models 101, and/or foundational or global learning models 103. The artificial intelligence models 102 may be mediated by a control system 105. In some aspects, the information model 101 may be communicatively coupled to a database 109 that includes enterprise specific data. The control system 105 may interface between the information model 101 and the foundational or global learning model 103. For example, the control system 105 may use the foundational or global learning model 103 to generate human comprehensible insights based on data and parameter sets provided by the information model 101. Additionally, the control system 105 may use the information model 101 to confirm the accuracy of output generated by the foundational or global learning model 103. Additionally, the control system 105 may use the information model 101 to access or edit information in the database 109. Additionally, the user interface 107 may be configured to allow inexpert users to confirm and accept the output of the combined system without requiring any data science expertise. Additionally, in some implementations the AI-based language models 102 can include a language model 104 that can be integrated between the informational model 101 and the control system 105. The language model 104 can be used to summarize information that is received via user input and also provide a prompt to the underlying AI-based model. In some implementations, the language model can be improved upon based on user provided feedback. In some implementations the language model can be provided with one or more sub-models that improve the language model with data such as hints (e.g., context-specific information that improves performance and accuracy by guiding decision making), few-shot training, context appropriate meta data, and the like.

One or more of the informational model 101 and the foundational or global learning model 103 can include artificial intelligence based models that are configured to be customized or specialized for user organizations. The control system 105 can interact with one or more user applications 110. Examples of user applications 110, include, but are not limited to, document summarization applications, natural language queries, what’s new analysis, analytics and the like. The informational model 101 can be embodied in or include a vector database, SQL generating model, and other aspects for retrieving information from a database.

In some aspects, a user interacting with a user application 110 may provide the user application 110 with a query that is transmitted to the underlying control system 105. The underlying global learning model 103 can use the provided query to select appropriate data from the information model 101 and provide it to the control system 105. The control system 105 can then provide the information to the global learning model 103.

In this manner, the control system 105 can be configured for both retrieval and processing. For example, during retrieval the control system 105 can provide information to the global learning model 103, have the appropriate data retrieved from the informational model 101 and returned to the control system 105. In some aspects, the data retrieved from the informational model 101 can be represented in tables, charts, or other structured data formats. During the processing aspect, the control system 105 may provide the data retrieved from the informational model 101 to the global learning model 103 for interpretation.

For example, in accordance with some embodiments a user provided query can state: “I am interested in sales are converted by lead source.” The underlying global learning model 103 can identify that the lead source is a channel. The corresponding data can be retrieved from the informational model based on the input from the global learning model. For example, all the data corresponding to the channel may be provided to the control system.

Foundation or global learning models 103 refer to large scale artificial intelligence based models that include a vast number of parameters that are used to process and understand large quantities of data. Foundation models 103 can include generative artificial intelligence (AI) tools that are able to produce content including text, imagery, audio, and synthetic data. These tools often include user interfaces that receive prompts, settings, or other parameters which are used to interact with the underlying artificial intelligence based models which are used to produce content. The quality of the output generated by the artificial intelligence models and foundation models 103 can vary greatly based on the user provided prompt and selected settings and/or parameters. For example, a generative model configured to generate an image may produce widely different outputs based on a user provided prompt of “draw a red door” in comparison to a user provided prompt of “draw a red door that is rounded and six feet tall for a house in the style of a children’s book.” Similarly, a generative model configured to generate a text may produce differing outputs based on a user provided prompt of “write me a song” in comparison to a user prompt of “write me a song in the style of pop music about summer.” A generative model configured to generate a text with a setting of “conversational mode” will produce a different text than one in a setting of “formal mode.” In other words, the same prompt may also provide different outputs and produce outputs of different quality based on the settings utilized by the underlying artificial intelligence based model 103 the prompt is being fed into. Examples of foundation models 103 can include large language models and generative models that are trained using transformer based deep learning techniques. Foundation models 103 can also be included in frontier models which are large scale advanced artificial intelligence models.

In some implementations, the artificial intelligence based model 102 may include a model that is an informational model 101 that has access to enterprise specific information. Enterprise specific information may include data on the variables and parameters that impact key performance indicators for an enterprise. Variables and parameters can include sales expenditure, marketing expenditure, revenue, win rate, statistics, inventory levels, logistics datasets, collections metrics, lead conversions, and the like. The information model 101 can include descriptive models, diagnostic models, predictive models, optimization models, prescriptive models, cost-benefit models, and/or constraint models. Optimization models may include those that balance cost-benefits of predictive models subject to business constraints. The information model 101 may produce one or more charts that provide insight into how an enterprise may be affected under different strategies and cost benefit assumptions. For example, information models may include those discussed in U.S. Patent Application No. 16/512,647 filed on July 16, 2019, entitled “ANALYZING PERFORMANCE OF MODELS TRAINED WITH VARYING CONSTRAINTS” the contents of which are hereby incorporated by reference, in their entirety. For example, information models can include a set of models trained on a dataset using a set of resourcing levels, which may specify a condition on outputs of models in the set of models.

In some implementations, the artificial intelligence based model 102 may include a model that is a foundational model, a class of large language models, a generative model, a reinforcement learning model, transfer learning model, generative AI based technologies, and the like, referred to as a global learning model 103. In some aspects, the artificial intelligence based model may be used on a global learning model 102 that is trained on a vast quantity of data. The artificial intelligence based model may utilize various learning algorithms including supervised learning and unsupervised techniques. The model may be trained on vast quantities of data.

Settings, prompts, and the like can greatly impact the output of the artificial intelligence based model 102. An output of an artificial intelligence based model 102 may be evaluated based on one or more metrics. Examples of metrics include the saliency, relevancy, context, or computational time required to generate a response. The quality of a response generated by an artificial intelligence based model 102 may also be evaluated on the creativity of the AI response, the amount of hallucinations generated by the AI model, the accuracy of facts produced by the AI model, the responsiveness of the AI model to the prompt, how well the AI followed user instructions, the speed of the response, and the like.

Examples of generative AI models 102 include large language models, foundational models, and the like. Examples of generative AI models include ChatGPT, GPT-3, GPT-4, PaLM 2, GPT-J, Dolly 2, Gemini, DALL-E, Bard/LaMDA, Midjourney, DeepMind, and the like. Generative AI models may include one or more artificial intelligence techniques such as neural networks, generative adversarial networks (GANs), transformers, autoencoders, and the like.

Settings of the artificial intelligence based model 102 can vary based on the type of artificial intelligence based model. In some implementations, a global learning model or a foundation model 10 that is a language model, may include settings such as temperature, frequency penalty, presence penalty, top P- value, or top K-value. The quality of the outcomes or responses to a prompt generated by a large language model may be affected based on the settings of the large language model including the temperature, frequency penalty, presence penalty, top p-value, and top k-value for the model. Settings for an artificial intelligence model may also include model parameters which provide guidelines for the output expected from the artificial intelligence model. For example, artificial intelligence models may be configured to generate responses or outputs that are more or less repeatable or creative, and/or have limitations or parameters on how often words or topics are repeated.

Settings can also include the chat tone which can indicate that a provided response should be in narrative format, as a bullet point list, provide a story, use metaphors, asking rhetorical question, to the point, and the like. The user can specify the components of the response they receive, the quantity of responses, types of retrievals and the like. The system can monitor user settings and determine if user settings are optimized for responses. Examples of chat tones can include neutral, bullet point, short and punchy, story teller, business, and the like. Selection of a chat tone can be facilitated by a drop down menu and selection.

As illustrated in FIG. 1, the control system 105 and/or user application 110 may be in communication with a user interface 107. The user interface can be configured to receive use feedback. User feedback can include user input via a graphical user interface such as 107 indicating a quality of response (e.g., thumbs up/down). In some implementations, user feedback may also allow for the user to provide text based feedback, selection of reviews and/or a user feedback score indicating how good a generated response is, and the like.

In some implementations, the prompt response can be provided. For example, in some aspects, the prompt response may be provided to a user interface 107. In some aspects, the prompt response may be provided to a user interface 107 in natural language form. Accordingly, a user may be able to use conversational language with some implementations of the current subject matter.

In some aspects, the user interface 107 may include any hardware or software components for communication between a user and the system described herein.

Examples of user interfaces 107 include applications, software programs, web applications, downloadable applications, and the like that may be present on a user interface device.

Examples of user interface devices, include, but are not limited to laptops, desktop computers, smartphones, tablets, car service devices, television devices, video game controller systems, coffee machines, refrigerators, and the like. The user interface may be in the form of a voice assistant, chat assistant, email assistant, image generation, and the like. In some aspects, the user interface may allow for enterprise specific users or enterprise customer users to interact with the prompt response.

In some aspects, a system built in accordance with those described in FIG. 1 can include an informational model that includes customized retrieval augmentation generation for extraction of analytics information from structured data sets. In some aspects, the analytics information can be for a business objective, or include proprietary data. Additionally, an informational model such as 101 can be configured to generate natural language queries in the form of a SQL statement and the like that can be used for retrieval augmentation for queries sent to a language model such as a foundational or global learning model 103 for a response. Additionally, in some aspects, the informational model can include one or more specialized templates that are compatible with semi-structured data. Accordingly, unstructured text can be retrieved by filtering through different structured fields. In this manner, a combined vector database can be utilized more efficiently with full, unstructured capability.

In some aspects, the informational model such as 101 can be used to generate SQL statements, Python statements, or statements in any other suitable language including computer code language.

In some aspects, a user application that is configured to generate a response to a query provided by a user can include a multi-step process. In a first step, information may be retrieved from an informational model such as 101 using a language model, deterministic system, vector database and the like. In a second step, the retrieved information can be provided to a global model which can include a language model. A user application can include various settings for both the retrieval of information in the first step, and the interactions with the global model in the second step.

As discussed herein, a parameter set can include one or more values indicating at least one of the type of the artificial intelligence based model, a setting of the artificial intelligence based model, or a configuration of the artificial intelligence based model. For example, a parameter set can indicate the type of AI model (e.g., Gemini, Chat GPT, etc.). The parameter set can also include one or more values indicating a setting such as a conversational tone or the like. Based on the provided parameter set the user application utilizing the artificial intelligence model can be run. The performance of the user application can then be determined based on one or more performance metrics. Performance metrics can include run time, quality metrics of responses generated for a prompt provided to the artificial intelligence model, processing power required for the generation of the response by the artificial intelligence model, and the like.

In some aspects, the method can receive user feedback characterizing performance of the user application. For example, a user may provide feedback by interacting with a graphical user interface. For example, a user can indicate if the response provided by the artificial intelligence model is good, bad, or neutral. A user can provide their feedback by selecting one or more graphical icons, or by ranking the performance of a plurality of models and the like. In some aspects, user feedback may provide an indication as to responses that are more salient or responsive in the context of an enterprise.

In some implementations, user feedback can be used to update one or more applications to use a particular artificial intelligence model and corresponding parameter setting based on the received user feedback. In some aspects, the artificial intelligence based model can be updated or retrained using the received user feedback.

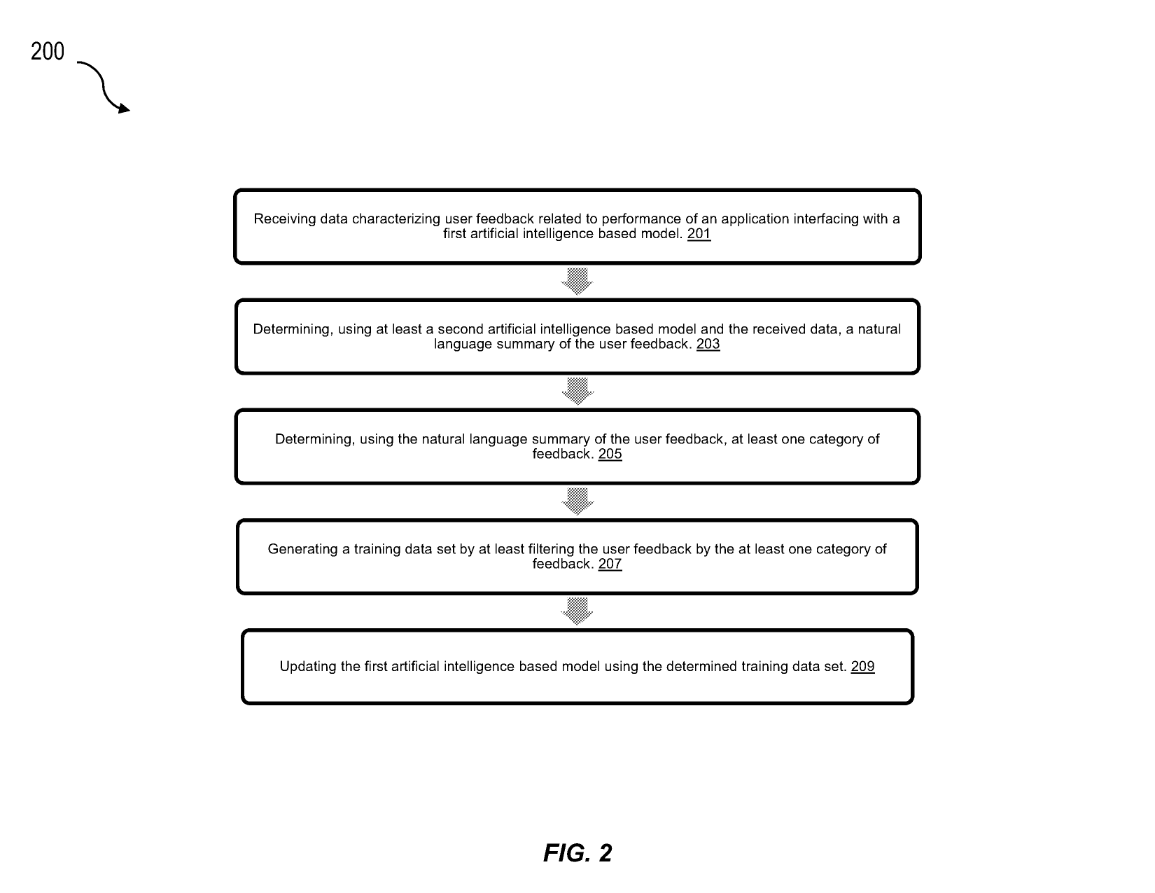

FIG. 2 is a flow-chart for a method in accordance with the aspects described herein. As shown, a method can include the steps of receiving data characterizing user feedback related to performance of an application interfacing with a first artificial intelligence based model 201, determining, using at least a second artificial intelligence based model and the received data, a natural language summary of the user feedback 203, determining, using the natural language summary of the user feedback, at least one category of feedback 205, determining a training data set by at least filtering the user feedback by the at least one category of feedback 207, and updating the first artificial intelligence based model using the determined training data set 209.

In some aspects, data characterizing user feedback related to performance of an application interfacing with an artificial intelligence based model can be received 201. This method can also monitor performance of a application interfacing with an artificial intelligence based model. In some implementations, the application can be interacting with an artificial intelligence based model. For example, a user may prompt or provide the artificial intelligence based models 102 of FIG. 1 with a query using an application 110. The artificial intelligence based model 102 may generate and provide a response to the query. The performance of the artificial intelligence based model can be monitored in that the response provided by the artificial intelligence based model can be evaluated for responsiveness, saliency, time taken, resources used to generate the response (e.g., financial, time, memory). In some aspects, feedback can include objective feedback that is generated by monitoring the user provided queries and the respective responses. Objective feedback may include the time, financial cost, memory resources used for generating the response. As discussed above, the artificial intelligence based model can include a frontier model, a foundational model, a large language model trained using transformers, a generative model and the like.

Performance of the application can also be monitored by having a user interface that is configured to receive user feedback regarding the performance of the application. For example, a user can indicate if the received response is a “good” response or a “bad” response, based on whether the response met the user’s expectations, was salient, relevant, detailed, accurate, and the like.

Contextual data can be obtained by monitoring the performance of the application and/or receiving explicit feedback from a user and/or generating objective feedback. Feedback can include thumbs up/thumbs down feedback, metadata, user questions, retrieval augmented generation (RAG) context provided to the language model, the captured response, the user feedback, and/or a user can provide input by an additional review textbox.

In some implementations, user provided feedback can be used to improve model performance. For example, in some embodiments, end-user feedback can be ingested and used to derive corrective signals that are provided to the model. For example, feedback instances indicating that a user-provided term (e.g., “region”) corresponds to a dataset field (e.g., “territory”) are aggregated and normalized to form a corrective signal such as a disambiguation rule or synonym mapping. The system applies the corrective signal such as the mapping during subsequent inference and/or training cycles such that follow-on prompts using the ambiguous term are resolved to the correct underlying data field, thereby reducing systematic errors arising from domain-specific jargon, abbreviations, or inconsistent nomenclature.

A system can receive user feedback data related to the performance of an application interfacing with the first artificial intelligence based model, such as model 102 in FIG. 2. The system can also receive the contextual data including explicit feedback from the user and/or objective feedback from direct monitoring of the performance of the application. Data characterizing the user feedback related to the performance of the application can be generated.

In some aspects, a second artificial intelligence based model can be applied to the user feedback to determine a natural language summary of the user feedback 203. For example, the second artificial intelligence based model can include a large language model that is trained to generate summaries of reviews. For example, the second artificial intelligence model can be trained on a collection of user feedback data including text based reviews, user ratings for responsiveness, saliency, metadata, user provided questions, retrieval augmented generation (RAG) context provided to the language model, the captured response, and the like. The second artificial intelligence model can be trained to generate summaries of the reviews. The summaries can include an indication of the query provided to the first artificial intelligence model, the response generated by the artificial intelligence model, and a summary of the user feedback for the query and generated response. The user feedback can be provided in natural language. In other words, in some aspects, the second artificial intelligence based model can be used to analyze the user query and generated response, look at feedback provided to the generated response, and provide relevant feedback to the artificial intelligence based model.

In some aspects, at least one category of feedback can be determined using the natural language summary of the user feedback 205. The categories of feedback can also be referred to as training categories. As discussed above, a second artificial intelligence model such as a trained large language model can be applied to the user feedback data to generate natural language summaries. Common themes or commonalities and the like can be identified among the natural language summaries to determine training categories. Commonalities can form categories of feedback or training categories. For example, the training category can indicate that users provided negative feedback for responses that utilized bullet points and therefore, the artificial intelligence model requires additional training to provide better responses with bullet points. In some aspects, the second artificial intelligence based model can be used to generate a summary of the user provided feedback. The summary and/or training categories produced by the second artificial intelligence based model can then be used to generate training data.

In some embodiments, a secondary model or classifier generates a set of feedback categories that characterize recurrent error patterns (e.g., terminology misunderstandings, acronym resolution failures, or output-format issues). The system prioritizes categories according to observed prevalence or impact and conducts a fine-tuning cycle directed to the highest-priority categories. As the model’s performance improves with respect to resolved categories, the distribution of feedback evolves in subsequent phases. For example, prior categories diminish in frequency and new categories such as stylistic preferences, response length, or subjective quality may emerge. The system iteratively repeats category detection and targeted fine-tuning in order to improve the quality of outputs produced by the system.

Training data can include a training data set that is determined by filtering the user feedback data by the determined categories of feedback 207. Training categories identified by applying the second artificial intelligence based model to the user feedback can be used to filter the user feedback to generate data characterizing the feedback and training data. In this manner, the training data can include feedback for a subset of the performances that are underperforming. By utilizing training categories to generate training data the disclosed systems and methods can be more resistant to erroneous or outlier feedback or swings in training due to a single performance review received from a user. Further, by filtering the training data based on training categories a subset of the entire possible space of training data is provided to the underlying artificial intelligence model such that there is less training data required for updating the model and so it requires less computational memory and time, while at the same time providing effective and targeted training.

In some implementations, the training data set may be smaller than the received data characterizing user feedback. Rather than retraining on the entire corpus of heterogeneous feedback (e.g., prompts, model responses, retrieval-augmented context, explicit approval/disapproval indicators, timing and cost metadata), the system can be configured to apply a second artificial intelligence based model (e.g., a large language model configured to summarize and categorize feedback) to produce natural-language summaries of the feedback and determine one or more recurrent feedback categories. The system then filters the received feedback using those categories to select only the portions relevant to identified underperforming behaviors (e.g., terminology disambiguation errors, output-format issues, or hallucination complaints). The resulting dataset is reduced in size (e.g., has fewer data records, has less content within each record, has fewer irrelevant/noisy data) and may include compressed summaries and/or a targeted subset of exemplars, thereby lowering memory usage and computational requirements during fine-tuning and/or reinforcement learning.

In some implementations, training categories can also be used to identify the areas of the model requiring updating the most. Training categories can be prioritized based on needs.

In some implementations, the determination of training data can be responsive to the generated data characterizing feedback exceeding a training threshold. For example, the system can be configured to generate training data after a number of runs of the application interfacing with the artificial intelligence based model (e.g., every 100 runs, every 1000 runs, every 10000 runs) or based on the number of negative feedback exceeding a threshold amount, and/or an elapsed time (e.g., every 24 hours, every 3 days, every 1 month).

Training data can be determined based on the data characterizing feedback. The training data can include one or more values indicating at least one of the type of artificial intelligence based model, a setting of the artificial intelligence based model and/or a configuration of the artificial intelligence based model. For example, a second artificial intelligence model can review user provided feedback indicating 20 thumbs up and 5 thumbs down and determine that the thumbs down responses were associated with responses that provided a bullet point listing to a query that stated “list the top ten performing products.” Accordingly, the training category “good” can associate bullet point listing formats to a query with the word “list.”

Training data can be used to update the artificial intelligence based model 209 by using fine-tuning. The fine-tuning may include training based on examples of the user provided prompt, generated response, and feedback. For example, the artificial intelligence based model 209 can be provided with positive examples that it should aim to achieve. In some implementations, the training data can be used to update the artificial intelligence based model 209 using reinforcement learning where the artificial intelligence based model is provided with feedback on produced outputs which may be positive or negative. In some implementations, training data can be used to update the artificial intelligence based model 209 using both fine-turning and reinforcement learning.

In some embodiments, the training data can be used to generate synthetic data. For example, the training data can be used to generate synthetic data that preserves the learned category semantics. Given a small set of human-validated exemplars (e.g., mappings indicating “region” should be interpreted as “territory” in a particular dataset), a synthetic data generator produces additional examples or training data that vary context, phrasing, and metadata. The synthetic data may be used to improve the robustness of the subsequent fine-tuning cycles.

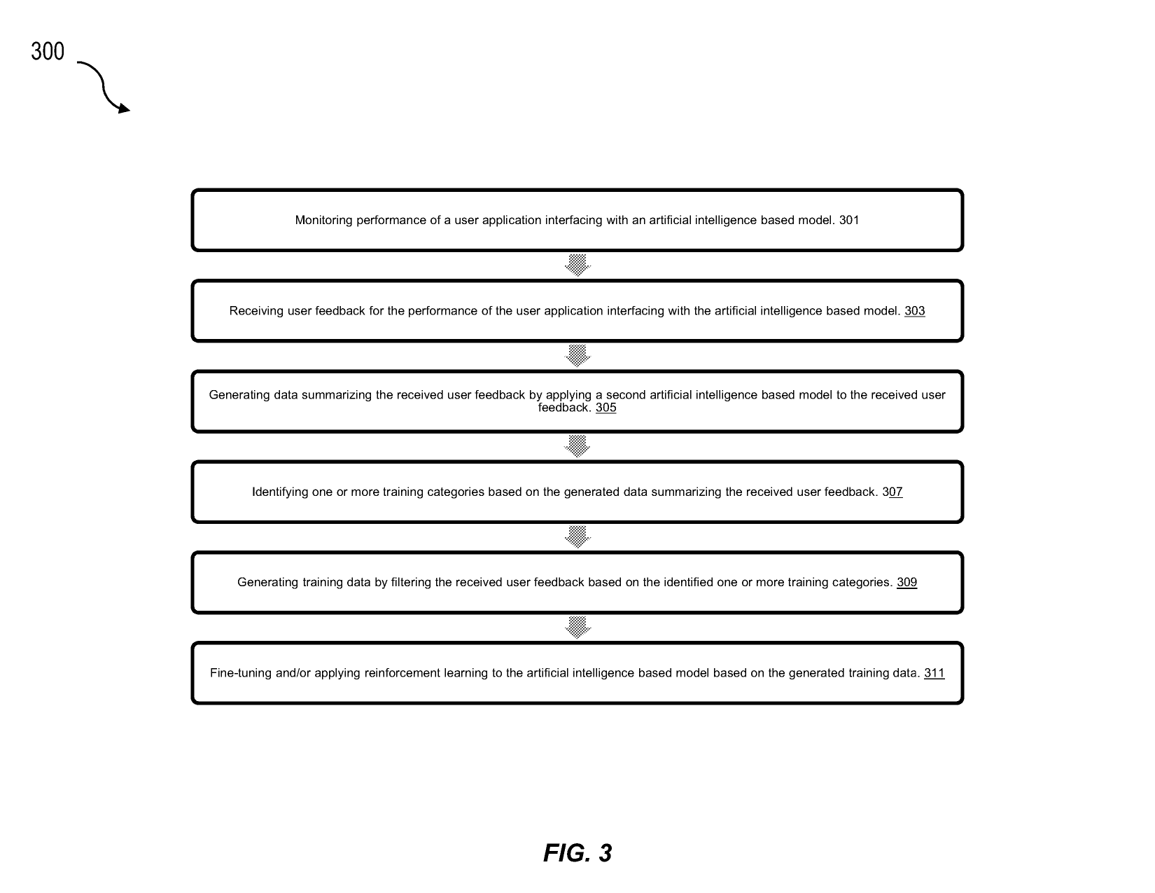

FIG. 3 provides a flow-chart for a method for accelerating training of a foundation model. As shown in FIG. 3, a process may include monitoring performance of a user application interfacing with an artificial intelligence based model 301, receiving user feedback for the performance of the user application interfacing with the artificial intelligence based model 303, generating data summarizing the received user feedback by applying a second artificial intelligence based model to the received user feedback 305, identifying one or more training categories based on the generated data summarizing the received user feedback 307, generating training data by filtering the received user feedback based on the identified one or more training categories 309, and fine-tuning the artificial intelligence based model and/or applying reinforcement learning based on the generated training data 311.

In some implementations, when the amount of available feedback reaches a threshold value it can be used to automatically train a new model.

In some implementations, user feedback to a response provided by the artificial intelligence based model can then be used to improve an artificial intelligence model. In some aspects, users can provide feedback to the system on which responses provided by the artificial intelligence model were the most relevant or responsive and which were not. Users can then edit the responses provided by the artificial intelligence model to a better response, which can then be saved and used as training data. User feedback, and training data generated by user feedback can be used for reinforcement learning, fine tuning, Low-Rank Adaptation of Large Language Models (LoRA), or other techniques for improving generative AI models. A user can be provided with an option of editing and saving the response of an artificial intelligence model as training data.

Few shot learning is an artificial intelligence framework in which an AI model learns to make predictions by training on a very small number of labeled examples. It can be used, for example, to train models for classification tasks when suitable training data is scarce.

Few shot feedback can include providing the underlying artificial intelligence model with additional information such as an example of prior prompts, queries, and responses that the user indicates as being responsive. For example, the artificial intelligence model underlying the application can be provided with a template that is linked to a parent and receive specific instructions that augment the user experience. For example, the specific instructions can include one or more examples of past queries and responses that the user found responsive. Accordingly, the provided responses can serve as examples for the underlying model. In some aspects, the user may provide feedback on the responses generated by the system. Feedback may be in the form of an input to the graphical user interface. For example, a user may click on a thumbs-up or thumbs-down icon positioned adjacent to the provided response to indicate that a response was “good” or highly relevant, or “bad” or less relevant. In some aspects, user feedback can be incorporated into retraining one or more prompt generators and/or underlying artificial intelligence models.

User can view the provided prompt, data from the informational model (e.g., chart data) that is provided to the global model, alongside the response produced by the global model. In some aspects, these few shot examples can then be provided to the model for improved responses.

Additionally, the user can provide feedback via the user interface, for example by selecting a thumbs up or thumbs down to indicate whether the provided response is responsive to the user’s query. The user can also indicate that they wish to incorporate the provided responses as a few shot entry to improve the underlying model, for example, by selecting the “build few shot to immediately improve AI” icon. Additionally, or alternatively the user can edit and save the provided response as training data for one or both of the informational model, or global model. The user can also export the response to a “looker” or other area to explore the underlying data corresponding to the provided response.

In some implementations, user feedback can be provided for one or more logical sub-steps taken by the artificial intelligence model in generating a response to the received prompt. The user feedback for the logical sub-steps can be incorporated into feedback on the reasoning steps taken by the artificial intelligence model thus providing chain-of-thought reasoning and feedback.

In some embodiments, selective fine-tuning can be performed by the system by excluding categories that meet or exceed stability criteria from further fine-tuning. After each phase of fine-tuning, the system may evaluates per-category performance using metrics such as residual error rate, confidence dispersion, or user complaint volume. Categories that satisfy a predefined sufficiency threshold are deprioritized or omitted from the next fine-tuning batch, conserving computational resources and avoiding redundant updates to already-stable behaviors. This selective approach concentrates optimization on unresolved “pain points,” shortening iteration cycles and reducing the risk of performance regressions caused by unnecessary parameter updates.

In some embodiments, the system mitigates accidental drift of the by suppressing low-volume or outlier feedback in domains determined as being stable. Following resolution of a category through broad user agreement (e.g., a widely supported synonym mapping), subsequent feedback in that domain may predominantly reflect non-standard usage. The system applies thresholds, outlier detection, or robust aggregation techniques to prevent such minority signals from re-introducing contradictory mappings during later training phases. In this way the system preserves stable behaviors while remaining responsive to genuine distribution shifts.

In some embodiments, the system improves long-term stability by operating within a controlled feedback loop that prioritizes validated, high-quality signals over uncurated external data. Because generative content on public networks may contain compounding artifacts or inaccuracies, the described category-driven training regimen limits the influence of degraded inputs by requiring that in some embodiments a threshold or quorum be met before modifying established behaviors.

Although a few variations have been described in detail above, other modifications or additions are possible. For example, some implementations may be used to improve meta data and associated information for dataset generation and prompt engineering. For example, the disclosed data models can be used to summarize data to generate a compressed set of data that can be used to help improve language models without having to pass a larger data set that includes uncompressed data. In some implementations, the disclosed methods may allow for the identification of the most important features of a model which can allow for quicker training of a language model when there is limited historical data for the language model. In some implementations, the discussed systems can provide methods for identifying and mitigating the effects of poisoned feedback. In poisoned feedback a bad actor may intentionally provide incorrect information to the model during fine tuning, reinforcement learning and/or chain of thought training. In some implementations, a secondary language model can screen the provided feedback, identify themes, and select feedback, fine-tuning, or reinforcement data that meets the themes from amongst the provided feedback. In this manner, poisoned feedback can be avoided.

The subject matter described herein provides many technical advantages. For example, the disclosed systems can be used to identify training categories that should be prioritized as more user feedback is received in relation to those training categories. Additionally, the disclosed systems can provide more efficient means of updating an artificial intelligence model by reducing the amount of training data provided to the model by using training categories. Further, as discussed herein, the disclosed systems and methods are resistant to influence by outlier user feedback.

In some implementations, the techniques described herein provide specific improvements to the functioning of computer systems that train and adapt artificial intelligence models. For example, the disclosed systems employ a category-driven, closed-loop training architecture in which a second artificial intelligence model automatically processes heterogeneous feedback signals generated during operation of a user application, including user prompts, model responses, retrieval-augmented context, explicit approval or disapproval indicators, and objective performance metrics. The second artificial intelligence model can transform this feedback into natural-language summaries and machine-interpretable feedback categories. These categories can then be used by the system to filter and select only the portions of the feedback that are relevant to identified areas of underperformance, thereby generating a targeted training dataset that is smaller, more accurate, and more computationally efficient than traditional full-corpus retraining approaches. The system can further apply defined training thresholds, such as minimum volumes of category-specific feedback or elapsed time intervals, to automatically trigger fine-tuning or reinforcement-learning updates to the primary artificial intelligence model. Additionally, the system can suppress low-volume, outlier, or potentially poisoned feedback and can avoid re-training model behaviors already determined to be stable, thereby reducing unnecessary parameter updates and preventing performance regressions. By integrating these steps within a specific architecture that includes an information model, a control system, and one or more artificial intelligence models, the disclosed implementations improve the efficiency, stability, and resource utilization of computer systems used for training and deploying large-scale artificial intelligence models.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing user feedback related to performance of an application executing on a computing device and interfacing with a first artificial intelligence based model;
determining, using at least a second artificial intelligence based model and the received data, a natural language summary of the user feedback;
determining using the natural language summary of the user feedback, at least one category of feedback;
determining a training data set by at least filtering the data characterizing the user feedback by the at least one category of feedback; and
updating the first artificial intelligence based model using the determined training data set.

2. The method of claim 1, further comprising:
monitoring performance of the application interfacing with the first artificial intelligence based model.

3. The method of claim 2, further comprising:
generating data characterizing user feedback to the monitored performance of the application.

4. The method of claim 1, wherein the first artificial intelligence based model comprises at least one of a foundational model, a multi-modal model, a reinforcement learning model, a transfer learning model, or a large language model.

5. The method of claim 1, wherein the second artificial intelligence model comprises a large language model configured to generate summaries of user feedback.

6. The method of claim 1, wherein the second artificial intelligence model comprises a large language model trained on user feedback and is configured to generate at least one of summaries of user feedback and/or categories of feedback.

7. The method of claim 1, wherein determining the training data set is responsive to the received data characterizing user feedback exceeding a training threshold.

8. The method of claim 7 wherein the training threshold comprises at least one of an elapsed time, a run count for the application, and/or a feedback count.

9. The method of claim 1, wherein the data characterizing user feedback comprises a prompt, a response corresponding to the prompt, user feedback to the response and/or a retrieval augmented generation (RAG) architecture for the prompt and corresponding response.

10. The method of claim 9, wherein the user feedback comprises a selection of one or more icons indicating approval and/or disapproval of a provided response.

11. The method of claim 1, further comprising:
displaying at least one of the data characterizing user feedback, determined training data set, performance of the application, or updates to the first artificial intelligence model in a graphical user interface.

12. The method of claim 1, wherein the training data set includes one or more values indicating at least one of a type of the first artificial intelligence based model, a setting of the first artificial intelligence based model, and/or a configuration of the first artificial intelligence based model.

13. The method of claim 12, wherein the setting comprises at least one of a temperature, frequency penalty, presence penalty, top p-value, and top k-value, chat tone, quantity of response, and/or type of retrieval.

14. The method of claim 1, wherein the training data set is smaller than the received data characterizing user feedback.

15. The method of claim 1, wherein the data characterizing user feedback comprises at least one of a prompt, a response generated by the first artificial intelligence based model corresponding to the prompt, or an indication of user approval or disapproval of the response, wherein the at least one category of feedback identifies a recurrent pattern in the user feedback and wherein updating the first artificial intelligence based model includes at least one of fine-tuning the first artificial intelligence based model using the determined training data set or applying reinforcement learning to the first artificial intelligence based model using the determined training data set.

16. A system comprising:
at least one data processor; and
memory coupled to the at least one data processor and storing instructions which, when executed by the at least one data processor, causes the at least one data processor to perform operations comprising:
receiving data characterizing user feedback related to performance of an application executing on a computing device and interfacing with a first artificial intelligence based model;
determining, using at least a second artificial intelligence based model and the received data, a natural language summary of the user feedback, a natural language summary of the user feedback;
determining using the natural language summary of the user feedback, at least one category of feedback;
determining a training data set by at least filtering the data characterizing the user feedback by the at least one category of feedback; and
updating the first artificial intelligence based model using the determined training data set.

17. The system of claim 16, wherein the operations further comprise:
monitoring performance of the application interfacing with the first artificial intelligence based model, and
generating data characterizing user feedback to the monitored performance of the application.

18. The system of claim 16, wherein the first artificial intelligence based model comprises at least one of a foundational model, a multi-modal model, a reinforcement learning model, a transfer learning model, or a large language model.

19. The system of claim 16, wherein the data characterizing user feedback comprises at least one of a prompt, a response generated by the first artificial intelligence based model corresponding to the prompt, or an indication of user approval or disapproval of the response.

20. A method comprising:
monitoring performance of a user application interfacing with an artificial intelligence based model;
receiving user feedback for the performance of the user application interfacing with the artificial intelligence based model;
generating data summarizing the received user feedback by at least applying a second artificial intelligence based model to the received user feedback;
identifying one or more training categories based on the generated data summarizing the received user feedback;
determining training data by filtering the received user feedback based on the identified one or more training categories; and
fine-tuning the artificial intelligence based model based on the generated training data and/or applying reinforcement learning to the artificial intelligence based model based on the generated training data.

21. The method of claim 20, wherein determining training data by filtering the received user feedback based on the identified one or more training categories comprises generating the training data responsive to the received user feedback exceeding a training threshold, wherein the training threshold comprises at least one of an elapsed time, a run count for the user application, or a feedback count.

22. The method of claim 20, wherein the one or more training categories identify recurrent error patterns in the user feedback, and wherein the generated training data is smaller than the received user feedback, thereby reducing computational resources required for fine-tuning or reinforcement learning.

23. The method of claim 20, wherein the data characterizing user feedback comprises at least one of a user, a response generated by the first artificial intelligence based model corresponding to the user, or an indication of user approval or disapproval of the response.
